(19) United States
(12) Patent Application Publication
(10) Pub. No.: US 2010/0142185 A1
(43) Pub. Date: Jun. 10, 2010

(54) LIGHT EMITTING DEVICE AND DISPLAY DEVICE

(75) Inventors: Hitoshi Wako, Miyagi (JP); Masashi Enomoto, Tokyo (JP); Yuichi Arisaka, Miyagi (JP); Hayato Hasegawa, Miyagi (JP); Toru Yatabe, Miyagi (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/632,416

(22) Filed: Dec. 7, 2009

(30) Foreign Application Priority Data
Dec. 8, 2008 (JP) 2008-311737

(51) Int. Cl. G02F 1/13357; F21V 19/00

(52) U.S. Cl. 362/97.1; 362/382

(57) ABSTRACT

A light emitting device having high light extraction efficiency and a display device having the same are provided. The light emitting device includes a light-emitting element having, on a substrate, a first electrode, a light-emitting layer, and a second electrode in order from the substrate side. The substrate has a first three-dimensional structure including a plurality of projections in nano order on the surface on the first electrode side. At least the first electrode out of the first electrode, the light-emitting layer, and the second electrode has a second three-dimensional structure modeled on the projections in the first three-dimensional structure on the surface on the side opposite to the substrate one another.

### CROSS REFERENCES TO RELATED APPLICATIONS

The present application claims priority to Japanese Priority Patent Application JP 2008-311737 filed in the Japan Patent Office on Dec. 8, 2008, the entire content of which is hereby incorporated by reference.

### BACKGROUND

The present disclosure relates to a light emitting device having a light-emitting element such as an organic electroluminescence (EL) element and a display device having the same.

As a backlight of a liquid crystal display device, a cold cathode fluorescent lamp has been widely used. Although a cold cathode fluorescent lamp has excellent characteristics with respect to the emission wavelength region, luminance, and the like, a reflector, a light guide plate, and the like are necessary for illuminating an entire plane. Consequently, it has points to be improved such as high cost of parts, high power consumption, and the like. To address the drawback, a liquid crystal display device using an organic EL element as a backlight has been proposed in recent years as described in, for example, Japanese Unexamined Patent Application Publication No. H10-125461. The organic EL element is a self-luminous light-emitting element, is manufactured by the thin film process, and has a number of excellent points such as low power consumption and a wide wavelength selection range.

Generally, an organic EL element has a configuration that, on a transparent substrate such as a glass substrate, a transparent electrode as an anode, a light-emitting layer including an organic EL layer, and a reflecting electrode as a cathode are stacked. The transparent electrode is made of, for example, ITO (Indium Tin Oxide) or the like and the reflecting electrode is made of Al (aluminum) or the like. The light-emitting layer has a stack structure of, for example, a hole transport layer, an organic EL layer, and an electron transport layer.

In the organic EL element having such a configuration, by applying DC voltage across the transparent electrode and the reflecting electrode, holes injected from the transparent electrode are introduced into the organic EL layer through the hole transport layer, and electrons injected from the reflecting electrode are introduced into the organic EL layer through the electron transport layer. In the organic EL layer, recombination between the introduced holes and electrons occurs, thereby generating light having a predetermined wavelength and emitting the generated light to the outside via the transparent electrode and the transparent substrate.

The organic EL element of this kind, however, has an issue such that the efficiency of extracting light generated by the light-emitting layer is low. One of the causes is, for example, reflection in the interface of each of layers in the organic EL element. For example, Japanese Unexamined Patent Application Publication No. 2006-351211 proposes a technique of providing the surface of the transparent substrate with roughness in micro-order and forming the light-emitting layer in a wavy shape modeled on the roughness. By the technique, light reflected by the reflecting electrode and returned to the light-emitting layer in the light generated by the light-emitting element is allowed to pass through a portion in a curved shape in the light-emitting layer, and the light extraction efficiency is improved.

However, in the method in Japanese Unexamined Patent Application Publication No. 2006-351211, the light extraction efficiency is not high enough, and further improvement is being in demand.

It is therefore desirable to provide a light emitting device having high light extraction efficiency and a display device having the same.

### SUMMARY

According to an embodiment, there is provided a first light emitting device including: on a substrate, a first electrode, a light-emitting layer, and a second electrode in order from the substrate side. The substrate has a first three-dimensional structure including a plurality of projections in nano order on the surface on the first electrode side. At least the first electrode out of the first electrode, the light-emitting layer, and the second electrode has a second three-dimensional structure modeled on the projections in the first three-dimensional structure on the surface on the side opposite to the substrate.

According to an embodiment, there is provided a first display device including a display panel driven on the basis of an image signal, and a light emitting device for emitting light which illuminates the display panel. The light emitting device has a substrate and has, on the surface opposite to the display panel of the substrate, a first electrode, a light-emitting layer, and a second electrode in order from the substrate side. The substrate has a first three-dimensional structure including a plurality of projections in nano order on the surface of the first electrode side. At least the first electrode out of the first electrode, the light-emitting layer, and the second electrode has a second three-dimensional structure modeled on the projections in the first three-dimensional structure on the surface on the side opposite to the substrate.

In the first light emitting device and the first display device of the embodiment, a first three-dimensional structure including a plurality of projections in nano order is provided on the surface of the first electrode side of the substrate. At least the first electrode out of the first electrode, the light-emitting layer, and the second electrode has a second three-dimensional structure modeled on the projections in the first three-dimensional structure on the surface on the side opposite to the substrate. Generally, the refractive index difference between the substrate and the first electrode is large, so that in the case where the interface between the substrate and the first electrode is a flat surface, the reflectance is high. However, in the embodiment, the three-dimensional structure having the projections in nano order is provided for the interface between the substrate and the first electrode, so that a change in the refractive index in the stack direction in and around the interface between the substrate and the first electrode is gentle. As a result, the reflectance in the interface between the substrate and the first electrode becomes low, so that the ratio that light generated by the light-emitting layer passes through the interface between the substrate and the first electrode becomes higher. In the embodiment, the three-dimensional structure having a plurality of projections in nano order is also formed on the surface of the first electrode, so that the light-emitting layer has a shape waved in the nano order scale. As compared with the case where the light-emitting layer has a flat shape, the surface area of the light-emitting layer becomes larger, so that the current density becomes also higher. Since the three-dimensional structure having the plurality of projections in nano order is formed in the first electrode, a part in which the electric field is locally strong is regularly generated in nano order in the light-emitting layer. Therefore, as compared with the case where the substrate is flat, both of the current efficiency (=luminance/current density) and power efficiency (=luminance/(current density×application voltage)) largely improve. In the case where the substrate is provided with the three-dimensional structure including the plurality of projections in micro order, as compared with the case where the substrate is flat, the power efficiency improves only slightly.

According to an embodiment, there is provided a second light emitting device comprising a light-emitting element having, on a substrate, a first electrode, a light-emitting layer, a second electrode and a barrier layer in order from the substrate side. The substrate has a first three-dimensional structure including a plurality of projections in nano order on the surface on the first electrode side. The first electrode, the light-emitting layer, the second electrode and the barrier layer have a second three-dimensional structure modeled on the projections in the first three-dimensional structure on the surface on the side opposite to the substrate.

According to an embodiment, there is provided a second display device including a display panel driven on the basis of an image signal, and a light emitting device for emitting light which illuminates the display panel. The light emitting device has a substrate and has, on the surface on the side of the display panel of the substrate, a first electrode, a light-emitting layer, a second electrode, and a barrier layer in order from the substrate side. The substrate has a first three-dimensional structure including a plurality of projections in nano order on the surface of the first electrode side. The first electrode, the light-emitting layer, the second electrode, and the barrier layer have a second three-dimensional structure modeled on the projections in the first three-dimensional structure on the surface on the side opposite to the substrate.

In the second light emitting device and the second display device according to an embodiment, the first three-dimensional structure including the plurality of projections in nano order is provided on the surface on the first electrode side of the substrate. The first electrode, the light-emitting layer, the second electrode, and the barrier layer are provided with the second three-dimensional structure modeled on the first three-dimensional structure on the surface on the side opposite to the substrate. Generally, the refractive index difference between the atmosphere (or vacuum) and the barrier layer is large. Consequently, in the case where the interface between the atmosphere (or vacuum) and the barrier layer is a flat surface, the reflectance is high. However, in the embodiment of the invention, the interface between the atmosphere (or vacuum) and the barrier layer is provided with a three-dimensional structure including a plurality of projections in nano order. Therefore, a change in the refractive index in the stack direction in and around the interface between the atmosphere (or vacuum) and the barrier layer is gentle. As a result, the reflectance in the interface between the atmosphere (or vacuum) and the barrier layer becomes low, so that the ratio that light generated by the light-emitting layer passes through the interface between the atmosphere (or vacuum) and the barrier layer becomes higher. In the embodiment of the present invention, the three-dimensional structure including a plurality of projections in nano order is also formed on the surface of the first electrode, so that the light-emitting layer has the shape waved in the nano order scale. As compared with the case where the light-emitting layer has a flat shape, the surface area of the light-emitting layer becomes larger, so that the current density becomes also higher. Since the three-dimensional structure having a plurality of projections in nano order is formed in the first electrode, a part in which the electric field is locally strong is regularly generated in nano order in the light-emitting layer. Therefore, as compared with the case where the substrate is flat, both of the current efficiency (=luminance/current density) and power efficiency (=luminance/(current density×application voltage)) largely improve. In the case where the substrate is provided with the three-dimensional structure including the plurality of projections in micro order, as compared with the case where the substrate is flat, the power efficiency improves only slightly.

According to the first light emitting device and the first display device of the embodiment, the ratio that light generated by the light-emitting layer passes through the interface between the substrate and the first electrode, and the current density become higher, a part in which the electric field becomes locally high is generated regularly in nano order in the light-emitting layer and, further, the current efficiency and the power efficiency largely improve. Thus, as compared with the case where the substrate is provided with the three-dimensional structure including the plurality of projections in micro order, the light extraction efficiency may be made higher.

According to the second light emitting device and the second display device of the embodiment of the present invention, the ratio that light generated by the light-emitting layer passes through the interface between the atmosphere (or vacuum) and the barrier layer, and the current density become higher, a part in which the electric field becomes locally high is generated regularly in nano order in the light-emitting layer and, further, the current efficiency and the power efficiency largely improve. Thus, as compared with the case where the substrate is provided with the three-dimensional structure including the plurality of projections in micro order, the light extraction efficiency may be made higher.

Additional features and advantages are described herein, and will be apparent from the following Detailed Description and the figures.

### BRIEF DESCRIPTION OF THE FIGURES

FIG. 1 is a cross section illustrating a display device according to an embodiment.

FIGS. 2A and 2B are a perspective view and a cross section, respectively, of a light emitting device included in an illumination device in FIG. 1.

FIG. 3 is a schematic diagram for explaining the action of the light emitting device in FIGS. 2A and 2B.

FIG. 4 is a relational diagram illustrating the relation between voltage and luminance.

FIG. 5 is a relational diagram illustrating the relation between voltage and current density.

FIG. 6 is a relational diagram illustrating the relation between the current density and current efficiency.

FIG. 7 is a relational diagram illustrating the relation between the current density and power efficiency.

FIG. 8 is a table illustrating results of FIGS. 4, 6, and 7.

FIG. 9 is a cross section showing a modification of the light emitting device in FIGS. 2A and 2B.

FIGS. 10A and 10B are a perspective view and a cross section, respectively, of another modification of the light emitting device of FIGS. 2A and 2B.

FIG. 11 is a schematic diagram for explaining the action of the light emitting device in FIGS. 10A and 10B.

FIG. 12 is a relational diagram illustrating the relation between voltage and luminance.

FIG. 13 is a relational diagram illustrating the relation between voltage and current density.

FIG. 14 is a relational diagram illustrating the relation between the current density and current efficiency.

FIG. 15 is a relational diagram illustrating the relation between the current density and power efficiency.

FIG. 16 is a table illustrating results of FIGS. 12, 14, and 15.

### DETAILED DESCRIPTION

Embodiemnts will be described below in detail with reference to the drawings. The description will be given in the following order.

1. Embodiment and Example 1 (with waves in an organic EL layer and a reflecting electrode)

2. Modification 1 (without waves in the organic EL layer and the reflecting electrode)

3. Modification 2 (each of projections in a substrate having a cone shape)

4. Modification 3 (Example 2) (top emission type light emitting device with a barrier layer)

### Embodiment

FIG. 1 illustrates an example of a schematic configuration of a display device 1 according to an embodiment of the present invention. The display device 1 has a liquid crystal display panel 10 (panel), an illuminating device 20 disposed on the rear side of the liquid crystal display panel 10, a casing 30 supporting the liquid crystal display panel 10 and the illuminating device 20, and a drive circuit (not shown) for driving the liquid crystal display panel 10 to display a video image. In the display device 1, the front face of the liquid crystal display panel 10 is directed to an observer (not shown).

Liquid Crystal Display Panel 10

The liquid crystal display panel 10 displays a video image. The liquid crystal display panel 10 is, for example, a display panel of a transmission type for driving pixels in response to a video signal and has a structure in which a liquid crystal layer is sandwiched by a pair of transparent substrates. The liquid crystal display panel 10 has, for example, in order from the illuminating device 20 side, a transparent substrate, a pixel electrode, an alignment film, a liquid crystal layer, an alignment film, a common electrode, a color filter, and a transparent substrate (which are not shown).

The transparent substrate is a substrate transparent to visible light, for example, a plate glass. On the transparent substrate on the illuminating device 20 side, active-type drive circuits including a TFT (Thin Film Transistor) electrically connected to a pixel electrode and a wiring are formed. The pixel electrode and the common electrode are made of, for example, ITO (Indium Tin Oxide). The pixel electrodes are arranged in a lattice or delta on the transparent substrate and function as electrodes for respective pixels. On the other hand, the common electrodes are formed on one surface on the color filter and function as common electrodes opposed to the pixel electrodes. The alignment film is made of a high polymer material such as polyimide and performs alignment process on the liquid crystal. The liquid crystal layer is made of a liquid crystal in, for example, the VA (Vertical Alignment) mode, TN (Twisted Nematic) mode, or STN (Super Twisted Nematic) mode. The liquid crystal layer has the function of changing the orientation of the polarizing axis of emission light from the illuminating device 20 by an application voltage from the drive circuit. By changing the alignment of liquid crystals in multiple stages, the orientation of the transmission axis per pixel is adjusted in multiple stages. The color filter separates light passed through the liquid crystal layer to, for example, the three primary colors of red (R), green (G), and blue (B) or four colors such as R, G, B, and white (W). The color filters are aligned in correspondence with the alignment of the pixel electrodes. A filter alignment (pixel alignment) generally includes stripe alignment, diagonal alignment, delta alignment, and rectangle alignment. A polarizer is a kind of an optical shutter and transmits only light in a predetermined vibration direction (polarized light). Polarizers are disposed so that their polarizing axes are different from each other by 90 degrees. With the arrangement, the emission light from the illuminating device 20 passes through or is interrupted via the liquid crystal layer.

Illuminating Device 20

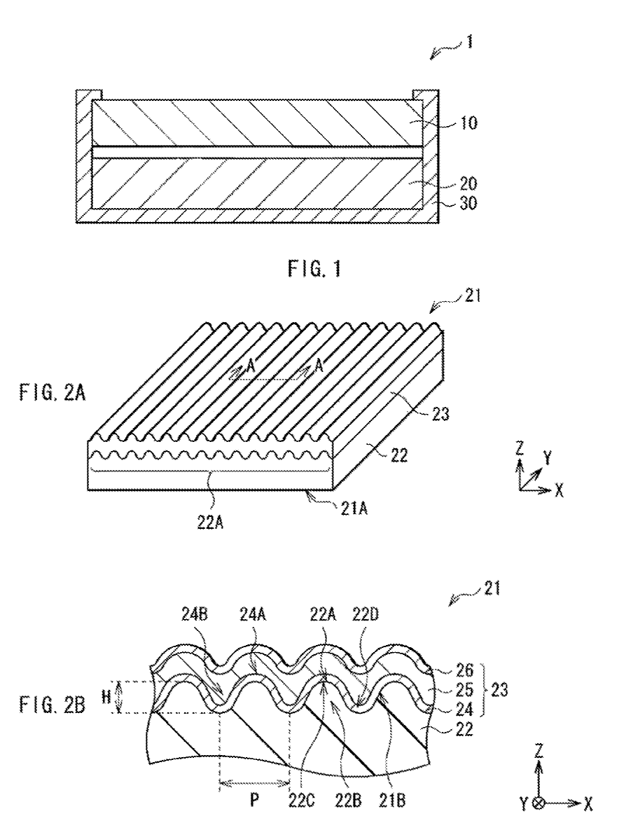

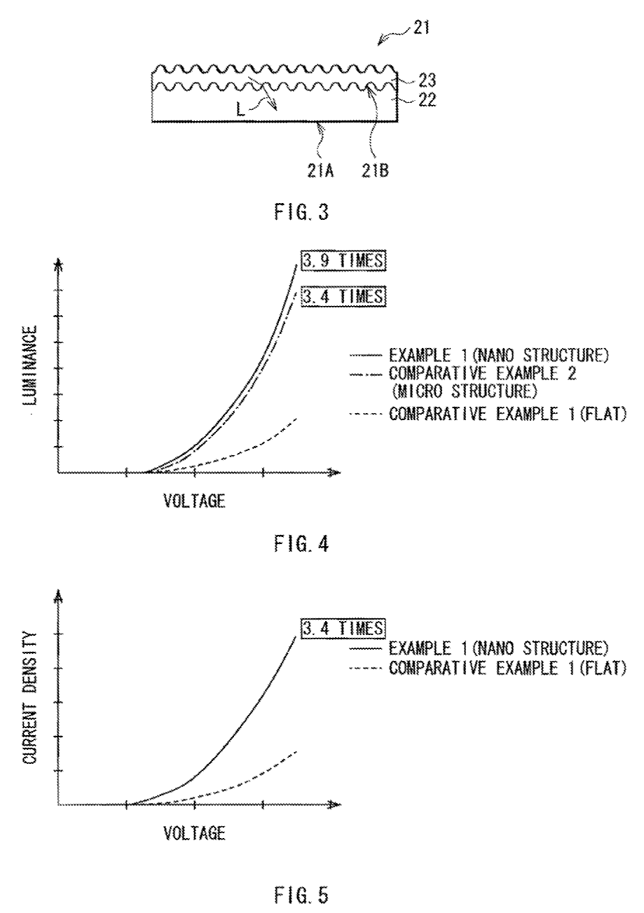

The illuminating device 20 has, for example, as a direct light source, a light emitting device 21 as shown in FIG. 2A. FIG. 2A is a perspective view of the light emitting device 21. FIG. 2B illustrates an example of a sectional configuration taken along line A-A of FIG. 2A. The light emitting device 21 has, for example, a substrate 22 and a light-emitting element 23. The light-emitting element 23 is formed on one surface of the substrate 22, concretely, on the surface on the side opposite to the liquid crystal display panel 10, of the substrate 22. That is, in the embodiment, the light-emitting element 23 is of a bottom emission type (a method of extracting light from the surface on the side opposite to the light emitting layer, of the substrate). The light-emitting element 23 is, for example, an organic EL element and is constructed by sequentially stacking, from the substrate 22 side, a transparent electrode 24, an organic EL layer 25 (light emitting layer), and a reflecting electrode 26 (FIG. 2B). The substrate 22 and the transparent electrode 24 are in contact with each other, and an interface 21B exists between the substrate 22 and the transparent electrode 24. The surface on the side opposite to the light-emitting element 23, of the substrate 22 is a light emission surface 21A of the light emitting device 21 and is disposed opposite to the liquid crystal display panel 10. FIG. 2A illustrates the case where nothing is provided on the light emission surface 21A. For example, an optical sheet such as a prism sheet may be provided.

Substrate 22

The substrate 22 is made of a material transparent to light generated by the organic EL layer 25, such as glass, plastic, or the like. The transmittance of the substrate 22 is, preferably, about 70% or higher with respect to light generated by the organic EL layer 25. Plastics which are suitably used for the substrate 22 include polyethylene terephthalate (PET), polyethylene naphthalate (PEN), polyimide, polycarbonate (PC), and the like. Although it is preferable that the substrate 22 has rigidity (self supporting property), the substrate 22 may have flexibility.

The substrate 22 has a three-dimensional structure 22A (first three-dimensional structure) having regularity in one direction (X-axis direction) in a stack plane on the surface on the transparent electrode 24 side. The three-dimensional structure 22A is constructed by disposing a plurality of columnar (rod-shaped) projections 22B extending in a direction (Y-axis direction) orthogonal to the X-axis direction in parallel in the X-axis direction. Preferably, the projection 22B has, for example, as shown in FIG. 2B, a rounded top 22C (having a projected curved surface). In the case where the top 22C has an acute shape, a portion corresponding to the top 22C in the light-emitting element 23 becomes fragile, and the life becomes shorter. Not only the top 22C but also a valley 22D formed by neighboring two projections 22B may be also rounded (may have a recessed curved surface). In the case where the top 22C and the valley 22D are rounded, the three-dimensional structure 22A has a shape which is waved in the X-axis direction.

At least one of the top 22C and the valley 22D may be flat. The surface of a portion between the top 22C and the valley 22D is preferably an inclined surface but may be a perpendicular surface parallel to the layer stack direction. The projection 22B may have, for example, various shapes such as a semicircular column shape, a trapezoidal shape, a polygonal column shape, and the like. All of the projections 22B may have the same shape or neighboring projections 22B may have shapes different from each other. A plurality of projections 22B on the substrate 22 may be classified into two or more kinds of projections and have the same shapes by kinds.

The projection 22B has a scale in nano order (for example, the wavelength band of light generated by the organic EL layer 25) in each of the thickness direction (Z-axis direction) and an array direction (X-axis direction). That is, the three-dimensional structure 22A has the regularity or periodicity in nano order. The height H of the projection 22B is, for example, 50 nm to 275 nm (preferably 50 nm to 192.5 nm), and the width (the pitch P in the array direction) of the projection 22B is, for example, 150 nm to 275 nm. The aspect ratio of the valley 22D specified by the height H and the width of the projection 22B lies preferably in the range of 0.2 to 2 both inclusive. When the aspect ratio exceeds 2, it becomes difficult to stack the light-emitting element 23 on the substrate 22. When the aspect ratio becomes below 0.2, a change in the refractive index in the stack direction in and around the interface 21B becomes sharp, and a total reflection attenuating effect which will be described later is hardly produced.

As described above, the three-dimensional structure 22A has a surface shape close to a flat surface from the viewpoint of geometric optics. As will be described later, the three-dimensional structure 22A presents a peculiar action different from that of a three-dimensional structure having regularity in micro-order. In the case where the substrate 22 is made of resin, the three-dimensional structure 22A may be produced by using, for example, the nano imprint technique. For example, the three-dimensional structure 22A may be produced by coating a supporting substrate with resin as the material of the substrate 22, pressing a mold having a three-dimensional structure which is obtained by inverting the three-dimensional structure 22A against the resin, and heating the resultant or irradiating the resultant with ultraviolet rays. In the case where the substrate 22 is made of glass, for example, the three-dimensional structure 22A may be produced as follows. First, a thermoset resin or ultraviolet curable resin is uniformly applied on the surface of glass. Next, a mold having a three-dimensional structure which is obtained by inverting the three-dimensional structure 22A is pressed against the resin, the shape of the mold is transferred onto the surface of the resin by using heat or ultraviolet rays, and the surface is uniformly corroded (removed) by reactive ion etching or the like. In such a manner, the three-dimensional structure 22A is formed on the glass substrate. It is also possible to form the three-dimensional structure 22A on the glass substrate by pressing the above-mentioned mold against glass or the like whose glass-transition temperature is relatively low and heating the mold.

Transparent Electrode 24

The transparent electrode 24 is made of a material which is transparent to light generated by the organic EL layer 25 and has conductivity. Examples of such a material include ITO, tin oxide, and IZO (indium zinc oxide). The transparent electrode 24 is formed on the surface of the three-dimensional structure 22A of the substrate 22 and has, on the surface opposite to the substrate 22, a three-dimensional structure 24A (second three-dimensional structure) modeled on the three-dimensional structure 22A. Specifically, the three-dimensional structure 24A has a surface shape similar to that of the three-dimensional structure 22A and obtained by disposing projections modeled on the projections 22B in parallel in the X-axis direction. In the three-dimensional structure 24A, a valley 24B formed by two neighboring projections has a depth which is equal to or smaller than that of the valley 22B. The aspect ratio of the valley 24B is equal to or less than that of the valley 22B. To form the three-dimensional structure 24A in the nano order scale at the time of forming the transparent electrode 24 on the substrate 22, the thickness of the transparent electrode 24 is preferably 50 nm to 500 nm both inclusive, more preferably, 80 nm to 150 nm both inclusive.

Organic EL layer 25

The organic EL layer 25 has a stack structure obtained by stacking, for example, in order from the transparent electrode 24 side, a hole injection layer, a hole transport layer, a light-emitting layer, and an electron transport layer. The organic EL layer 25 may include, as necessary, a layer other than the above-described layers or may not include one or both of the hole transport layer and the electron transport layer. The hole injection layer is provided to increase the hole injection efficiency. The hole transport layer is provided to increase the efficiency of transporting holes into the light-emitting layer. The light-emitting layer is provided to cause recombination between electrons and holes by the electric field generated by the transparent electrode 24 and the reflecting electrode 26. The electron transport layer is provided to increase the efficiency of transporting electrons to the light-emitting layer.

The organic EL layer 25 is formed on the surface of the three-dimensional structure 24A of the transparent electrode 24 and has a shape almost modeled on that of the three-dimensional structure 24A on the surface opposite to the substrate 22. Specifically, the organic EL layer 25 has a shape (three-dimensional structure) which is waved in a scale of nano order (for example, the wavelength band of light generated by the organic EL layer 25) in the X-axis direction. With the shape, the surface area per unit area viewed from the stack direction in the organic EL layer 25 (particularly, the light-emitting layer) becomes larger than that in the case where the organic EL layer 25 is formed on the flat surface. The organic EL layer 25 may be formed on the entire surface of the transparent electrode 24 or formed in a pattern. The pattern shape is not limited but various shapes such as a square shape and a stripe shape may be employed. The thickness of the organic EL layer 25 is, preferably, 50 nm to 1,000 nm (more preferably, less than the wavelength of visible light, namely 50 nm to 780 nm) both inclusive to form waves in the above-described nano order scale when the organic EL layer 25 is formed on the transparent electrode 24.

Reflecting Electrode 26

The reflecting electrode 26 is formed of a material which reflects light generated by the organic EL layer 25 at high reflectance, such as aluminum, platinum, gold, chromium, tungsten, nickel, an alloy including at least one of these metals, or the like. The reflecting electrode 26 is formed on the surface (wavy surface) of the organic EL layer 25 and has, in the surface opposite to the substrate 22, a shape modeled on the waves in the surface of the organic EL layer 25. That is, the reflecting electrode 26 has a shape (three-dimensional structure) waved in a scale of nano order (for example, the wavelength band of light generated by the organic EL layer 25) in the X-axis direction like the organic EL layer 25.

The action and effect of the display device 1 of the embodiment will now be described.

In the embodiment, by application of voltage across the transparent electrode 24 and the reflecting electrode 26, holes are introduced from the transparent electrode 24 into the light-emitting layer in the organic EL layer 25, and electrons are introduced from the reflecting electrode 26 to the light-emitting layer in the organic EL layer 25. In the light-emitting layer, by recombination of the introduced holes and electrons, organic EL molecules are excited, and light having a predetermined wavelength is generated. The generated light is emitted from the light emission surface 21A to the back face of the liquid crystal display panel 10 via the transparent electrode 24 and the substrate 22. In the liquid crystal display panel 10, incident light from the illuminating device 20 is modulated on the basis of an image signal and subjected to color separation by the color filters, and the resultant light goes out to the observer side. In such a manner, a color image is displayed.

In the embodiment, the three-dimensional structure 22A having regularity in nano order in the X-axis direction is provided on the surface on the transparent electrode 24 side of the substrate 22. At least the transparent electrode 24 out of the transparent electrode 24, the organic EL layer 25, and the reflecting electrode 26 is provided with the three-dimensional structure 24A modeled on the three-dimensional structure 22A on the surface on the side opposite to the substrate 22. Generally, the refractive index difference between the substrate 22 and the transparent electrode 24 is large. Consequently, in the case where the interface 21B between the substrate 22 and the transparent electrode 24 is a flat surface, the reflectance is high. However, in the embodiment, the three-dimensional structure 22A having regularity in nano order is provided for the interface 21B, so that a change in the refractive index in the stack direction in and around the interface 21B is gentle. As a result, the reflectance in the interface 21B becomes low, so that the ratio that light L generated by the organic EL layer 25 passes through the interface 21B and goes out from the light emission surface 21A becomes higher.

In the embodiment, the three-dimensional structure 24A having regularity in nano order is also formed on the surface of the transparent electrode 24, so that the organic EL layer 25 (particularly, the light-emitting layer in the organic EL layer 25) has a shape waved in the nano order scale. As compared with the case where the light-emitting layer has a flat shape, the surface area of the light-emitting layer becomes larger, so that the current density becomes also higher. Since the three-dimensional structure 24A having the regularity in nano order is formed in the transparent electrode 24, a part in which the electric field is locally strong is regularly generated in nano order in the light-emitting layer. Therefore, as compared with the case where the substrate 22 is flat and the case where a three-dimensional structure having regularity in micro-order is provided for the substrate 22, both of the current efficiency (=luminance/current density) and power efficiency (=luminance/(current density×application voltage)) largely improve.

### Example 1

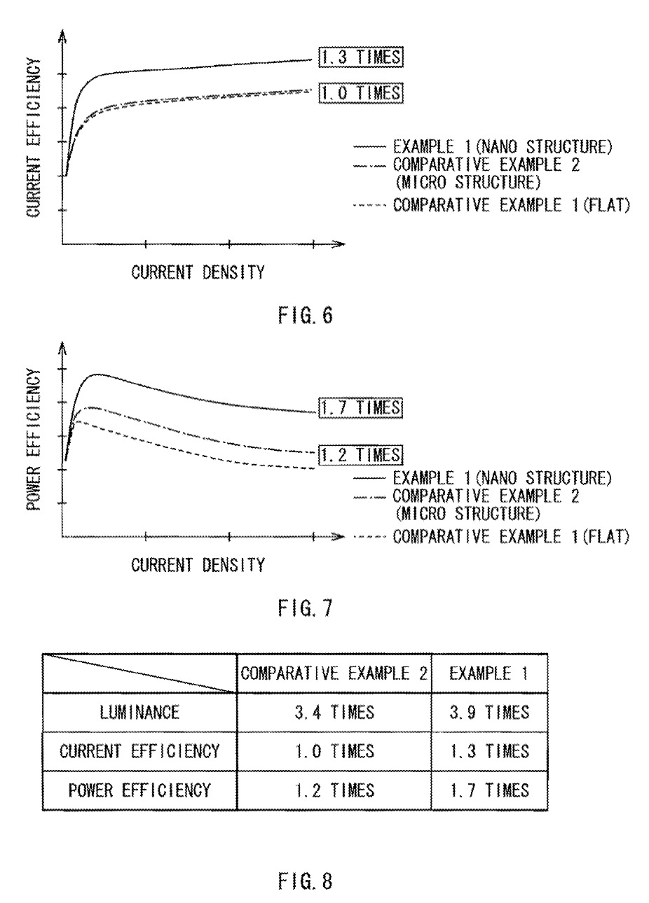

FIG. 4 illustrates the relation between voltage and luminance in comparative examples 1 and 2 and example 1. FIG. 5 illustrates the relation between voltage and current density in the comparative example 1 and the example 1. FIG. 6 illustrates the relation between the current density and current efficiency (=luminance/current density) in the comparative examples 1 and 2 and the example 1. FIG. 7 illustrates the relation between the current density and power efficiency (=luminance/application voltage) in the comparative examples 1 and 2 and the example 1. FIG. 8 is a table illustrating results of FIGS. 4, 6, and 7.

In the comparative examples 1 and 2 and the example 1, quartz glass, crystal, non-alkali glass, phosphate glass, or the like was used as the material of the substrate 22, and ITO was used as the material of the transparent electrode 24. In the comparative examples 1 and 2 and the example 1, the thickness of the organic EL layer was set to 300 nm. In the comparative example 1, the interface 21B was planarized. In the comparative example 2, the interface 21B was provided with the three-dimensional structure having regularity in micro-order. In the example 1, the interface 21B was provided with the three-dimensional structure 22A having regularity in nano order as in the above embodiment. In both of the comparative example 2 and the example 1, by disposing a plurality of column-shaped (rod-shaped) projections extending in the Y-axis direction in the X-axis direction, three-dimensional structures were formed. The height of the projection in the comparative example 2 was set to 20 μm, and the pitch was set to 50 μm. On the other hand, the height of the projection (projection 22B) of the example 1 was set to 50 nm, and the pitch (P) was set to 150 nm.

It is understood from FIG. 4 that, in the example 1, luminance which is 3.9 times as high as that of the comparative example 1 was obtained. On the other hand, in the comparative example 2, luminance which is only 3.4 times as high as that of the comparative example 1 was obtained. It is understood from FIG. 5 that, in the example 1, current density which is 3.4 times as high as that of the comparative example 1 was obtained. It is understood from FIG. 6 that, in the example 1, current efficiency which is 1.3 times as high as that of the comparative example 1 was obtained. On the other hand, in the comparative example 2, the current efficiency which is almost the same as that of the comparative example 1 was obtained. It is understood from FIG. 7 that, in the example 1, the power efficiency which is 1.7 times as high as that of the comparative example 1 was obtained. On the other hand, in the comparative example 2, the power efficiency which is 1.2 times as high as that of the comparative example 1 was obtained.

It is understood from the above that, in the case where the substrate 22 is provided with a three-dimensional structure having regularity in micro-order, as compared with the case where the substrate 22 is flat, the current efficiency hardly improves, and the power efficiency slightly improves. On the other hand, in the embodiment, both of the current efficiency and the power efficiency improve largely. Therefore, as compared with the case where the substrate 22 is flat or the case where the substrate 22 is provided with a three-dimensional structure having regularity in micro-order, the light extraction efficiency is allowed to be made higher.

The embodiments but may be variously modified.

### Modification 1

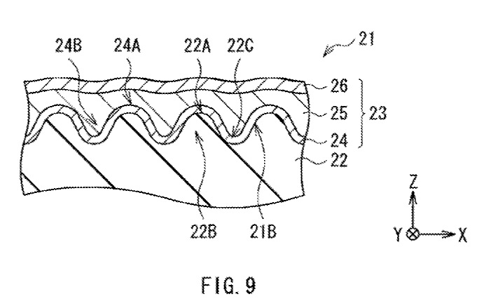

For example, although both of the organic EL layer 25 and the reflecting electrode 26 have a wavy shape due to the influence of the projections 22B on the substrate 22, they may be almost flat. For example, as shown in FIG. 9, the surface on the side opposite to the substrate 22, of each of the organic EL layer 25 and the reflecting electrode 26 may almost flat.

Although the case where the transparent electrode 24 is used as an anode and the reflecting electrode 26 is used as a cathode has been described in the foregoing embodiment, the anode and cathode maybe interchanged. The transparent electrode 24 may be used as a cathode, and the reflecting electrode 26 may be used as an anode.

### Modification 2

Although the three-dimensional structure 22A is constructed by arranging a plurality of columnar projections 22B extending in the Y-axis direction in parallel in the X-axis direction in the foregoing embodiment, for example, it may be also constructed by two-dimensionally arranging cone-shaped projections in the X-axis and Y-axis directions.

### Modification 3 (Example 2))

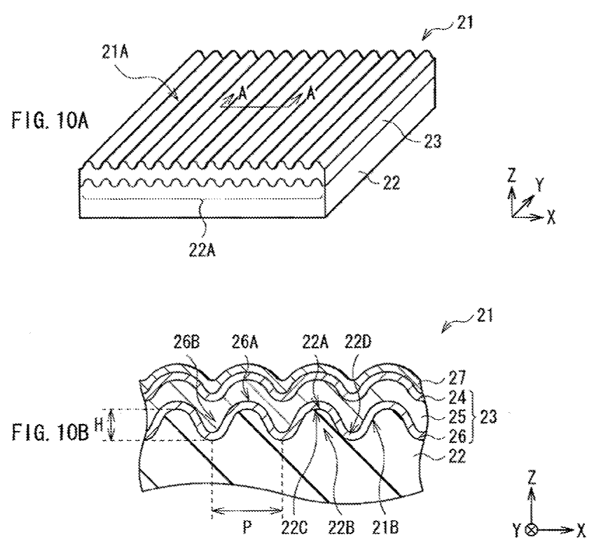

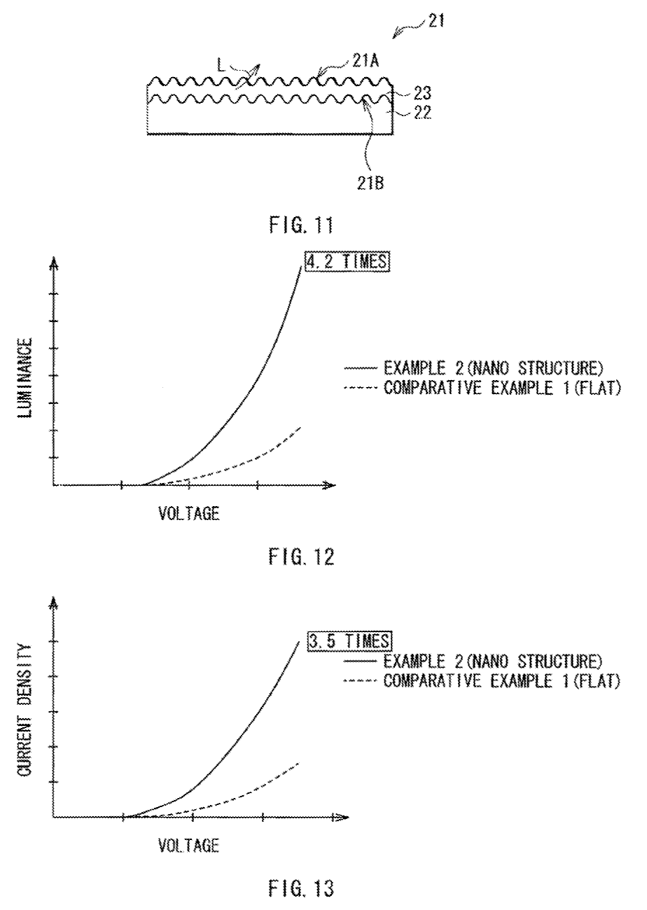

Although the light-emitting element 23 is of the bottom emission type in the foregoing embodiment, the light-emitting element 23 may be of the top emission type. Concretely, the light-emitting element 23 may be formed on the surface on the liquid crystal display panel 10 side in the substrate 22. In this case, for example, the light-emitting element 23 is constructed by stacking the reflecting electrode 26, the organic EL layer 25, the transparent electrode 24, and a barrier layer 27 in order from the substrate 22 side as shown in FIGS. 10A and 10B. The light emission surface 21A is on the transparent electrode 24 side. The barrier layer 27 is made of a material having relatively high reflective index such as SiN. FIG. 10A is a perspective view of the light emitting device 21 according to the modification, and FIG. 10B illustrates an example of a sectional configuration taken along line A-A of FIG. 10A.

In the modification, the reflecting electrode 26 is formed on the surface of the three-dimensional structure 22A of the substrate 22, and has a three-dimensional structure 26A modeled on the three-dimensional structure 22A on the surface opposite to the substrate 22. Specifically, the three-dimensional structure 26A has a surface shape similar to that of the three-dimensional structure 22A and is obtained by disposing projections approximated to the projections 22B in parallel in the X-axis direction. In the three-dimensional structure 26A, a valley 26B formed by two neighboring projections has a depth which is equal to or smaller than that of the valley 22B. The aspect ratio of the valley 26B is equal to or less than that of the valley 22B. To form the three-dimensional structure 26A in the nano order scale at the time of forming the reflecting electrode 26 on the substrate 22, the thickness of the reflecting electrode 26 is preferably 50 nm to 300 nm both inclusive, more preferably, 80 nm to 150 nm both inclusive.

In the modification, the organic EL layer 25 is formed on the surface of the three-dimensional structure 26A of the reflecting electrode 26 and has a shape almost modeled on the three-dimensional structure 26A on the surface opposite to the substrate 22. Specifically, the organic EL layer 25 has a shape (three-dimensional structure) which is waved in a scale of nano order (for example, the wavelength band of light generated by the organic EL layer 25) in the X-axis direction. With the shape, the surface area per unit area viewed from the stack direction in the organic EL layer 25 (particularly, the light-emitting layer) becomes larger than that in the case where the organic EL layer 25 is formed on the flat surface. The organic EL layer 25 may be formed on the entire surface of the reflecting electrode 26 or formed in a pattern. The pattern shape is not limited but various shapes such as a square shape and a stripe shape may be employed. The thickness of the organic EL layer 25 is, preferably, 50 nm to 1,000 nm (more preferably, less than the wavelength of visible light, namely 50 nm to 780 nm) both inclusive to form waves in the above-described nano order scale when the organic EL layer 25 is formed on the reflecting electrode 26.

In the modification, the transparent electrode 24 is formed on the surface (wavy surface) of the organic EL layer 25 and has a shape almost modeled on the waves in the surface of the organic EL layer 25, on the surface opposite to the substrate 22. That is, like the organic EL layer 25, the transparent electrode 24 has a shape (three-dimensional shape) which waves in a scale of nano order (for example, the wavelength band of light generated by the organic EL layer 25) in the X-axis direction. In the modification, the transparent electrode 24 is made of, for example, IZO, ITO, a metal thin film having a thickness of about 10 nm or less, or the like.

In the display device of the modification, by application of voltage across the transparent electrode 24 and the reflecting electrode 26, holes are introduced from the transparent electrode 24 into the light-emitting layer in the organic EL layer 25, and electrons are introduced from the reflecting electrode 26 to the light-emitting layer in the organic EL layer 25. In the light-emitting layer, by recombination of the introduced holes and electrons, organic EL molecules are excited, and light having a predetermined wavelength is generated. The generated light is emitted in a plane shape from the light emission surface 21A to the back face of the liquid crystal display panel 10 via the transparent electrode 24. In the liquid crystal display panel 10, incident light from the illuminating device 20 is modulated on the basis of an image signal and subjected to color separation by the color filters, and the resultant light goes out to the observer side. In such a manner, a color image is displayed.

In the modification, the three-dimensional structure 26A having regularity in nano order in the X-axis direction is provided on the surface on the reflecting electrode 26 side of the substrate 22. At least the reflecting electrode 26 out of the reflecting electrode 26, the organic EL layer 25, the transparent electrode 24, and the barrier layer 27 is provided with the three-dimensional structure 26A modeled on the three-dimensional structure 22A on the surface on the side opposite to the substrate 22. Further, on the surface of the three-dimensional structure 26A, the organic EL layer 25, the transparent electrode 24, and the barrier layer 27 are stacked. The surface on the side opposite to the substrate 22, of the organic EL layer 25, the transparent electrode 24, and the barrier layer 27 has a shape waved in a nano order scale in the X-axis direction and has regularity in nano order.

Generally, the refractive index difference between the atmosphere (or vacuum) and the barrier layer 27 is large. Consequently, in the case where the interface between the atmosphere (or vacuum) and the barrier layer 27 is a flat surface, the reflectance is high. However, in the embodiment, the interface is provided with a structure having regularity modeled on the three-dimensional structure 22A having regularity in nano order is provided for the interface, so that a change in the refractive index in the stack direction in/around the light emission surface 21A is gentle. As a result, the reflectance in the interface becomes low, so that the ratio that light L generated by the organic EL layer 25 is emitted from the light emission surface 21A to the outside becomes higher.

In the modification, a three-dimensional structure having regularity in nano order is also formed on the surface of the reflecting electrode 26, so that the organic EL layer 25 (particularly, the light-emitting layer in the organic EL layer 25) also has the shape waved in the nano order scale. As compared with the case where the light-emitting layer has a flat shape, the surface area of the light-emitting layer becomes larger, so that the current density becomes also higher. Since the three-dimensional structure having the regularity in nano order is formed in the reflecting electrode 26, a part in which the electric field is locally strong is regularly generated in nano order in the light-emitting layer. Therefore, as compared with the case where the substrate 22 is flat and the case where a three-dimensional structure having regularity in micro-order is provided for the substrate 22, both of the current efficiency (=luminance/current density) and power efficiency (=luminance/(current density×application voltage)) largely improve.

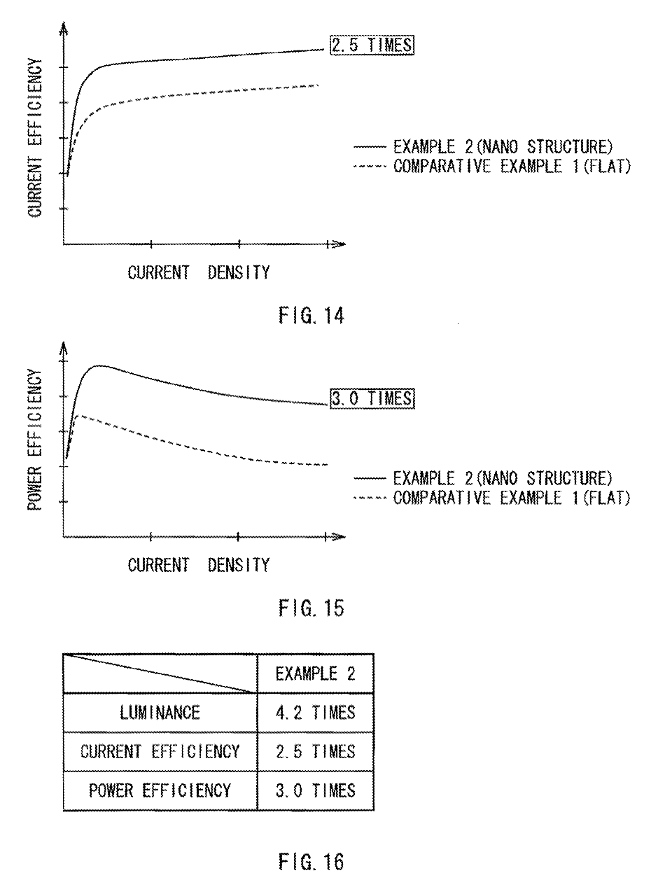

FIG. 12 illustrates the relation between voltage and luminance in comparative example 1 and example 2 (an example related to the modification). FIG. 13 illustrates the relation between voltage and current density in the comparative example 1 and the example 2. FIG. 14 illustrates the relation between the current density and current efficiency (=luminance/current density) in the comparative example 1 and the example 2. FIG. 15 illustrates the relation between the current density and power efficiency (=luminance/(current density×application voltage)) in the comparative example 1 and the example 2. FIG. 16 is a table illustrating results of FIGS. 12, 14, and 15.

In the comparative example 1 and the example 2, quartz glass, crystal, non-alkali glass, phosphate glass, or the like was used as the material of the substrate 22, and ITO was used as the material of the transparent electrode 24. In the comparative example 1 and the example 2, the thickness of the organic EL layer was set to 300 nm. In the comparative example 1, the interface 21B was planarized. In the example 2, the interface 21B was provided with the three-dimensional structure 22A having regularity in nano order. In the example 2, by disposing a plurality of column-shaped (rod-shaped) projections extending in the Y-axis direction in the X-axis direction, a three-dimensional structure was formed. The height of the projection in the example 2 (the projection 22B) was set to 50 nm, and the pitch (P) was set to 150 nm.

It is understood from FIG. 12 that, in the example 2, luminance which is 4.2 times as high as that of the comparative example 1 was obtained. It is understood from FIG. 13 that, in the example 2, current density which is 3.5 times as high as that of the comparative example 1 was obtained. It is understood from FIG. 14 that, in the example 2, current efficiency which is 2.5 times as high as that of the comparative example 1 was obtained. It is understood from FIG. 15 that, in the example 2, the power efficiency which is 3.0 times as high as that of the comparative example 1 was obtained.

It is understood from the above that, in the modification, both of the current efficiency and the power efficiency improve largely. Therefore, as compared with the case where the interface 21B of the substrate 22 is planarized or the case where the substrate 22 is provided with a three-dimensional structure having regularity in micro-order, the light extraction efficiency is made higher.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A light emitting device comprising:
a light-emitting element having, on a substrate, a first electrode, a light-emitting layer, and a second electrode in order from the substrate side,
wherein the substrate has a first three-dimensional structure including a plurality of projections in nano order on the surface on the first electrode side, and
at least the first electrode out of the first electrode, the light-emitting layer, and the second electrode has a second three-dimensional structure modeled on the projections in the first three-dimensional structure on the surface on the side opposite to the substrate.

2. The light emitting device according to claim 1, wherein the plurality of projections included in the first three-dimensional structure have the same shape.

3. The light emitting device according to claim 1, wherein the first three-dimensional structure have two or more kinds of projections, and
the projections have the same shape by kind.

4. The light emitting device according to claim 1, wherein the plurality of projections has regularity in nano order at least in a first direction of a stack layer plane.

5. The light emitting device according to claim 1, wherein the plurality of projections is formed so as to extend in a direction orthogonal to the first direction and arranged in parallel in the first direction.

6. The light emitting device according to claim 1, wherein aspect ratio of the first three-dimensional structure lies in the range of 0.2 to 2 both inclusive.

7. The light emitting device according to claim 1, wherein the second three-dimensional structure of the first electrode has a rounded top.

8. The light emitting device according to claim 1, wherein both of the substrate and the first electrode are made of a material transparent to light generated by the light-emitting layer.

9. A light emitting device comprising:
a light-emitting element having, on a substrate, a first electrode, a light-emitting layer, a second electrode and a barrier layer in order from the substrate side,
wherein the substrate has a first three-dimensional structure including a plurality of projections in nano order on the surface on the first electrode side, and
the first electrode, the light-emitting layer, the second electrode and the barrier layer have a second three-dimensional structure modeled on the projections in the first three-dimensional structure on the surface on the side opposite to the substrate.

10. The display device according to claim 9, wherein the plurality of projections included in the first three-dimensional structure have the same shape one another.

11. The display device according to claim 9, wherein the first three-dimensional structure has two or more kinds of projections, and
the projections have the same shape by kind.

12. The display device according to claim 9, wherein the plurality of projections have regularity in nano order at least in a first direction of a stack layer plane.

13. A display device comprising:
a display panel driven on the basis of an image signal; and
a light emitting device for emitting light which illuminates the display panel,
wherein the light emitting device has a substrate and has, on the surface opposite to the display panel of the substrate, a first electrode, a light-emitting layer, and a second electrode in order from the substrate side,
the substrate has a first three-dimensional structure including a plurality of projections in nano order on the surface of the first electrode side, and
at least the first electrode out of the first electrode, the light-emitting layer, and the second electrode has a second three-dimensional structure modeled on the projections in the first three-dimensional structure on the surface on the side opposite to the substrate.

14. The display device according to claim 13, wherein the plurality of projections included in the first three-dimensional structure have the same shape one another.

15. The display device according to claim 13, wherein the first three-dimensional structure has two or more kinds of projections, and
the projections have the same shape by kind.

16. The display device according to claim 13, wherein the plurality of projections have regularity in nano order at least in a first direction of a stack layer plane.

17. A display device comprising:
a display panel driven on the basis of an image signal; and
a light emitting device for emitting light which illuminates the display panel,
wherein the light emitting device has a substrate and has, on the surface on the side of the display panel of the substrate, a first electrode, a light-emitting layer, a second electrode, and a barrier layer in order from the substrate side,
the substrate has a first three-dimensional structure including a plurality of projections in nano order on the surface of the first electrode side, and
the first electrode, the light-emitting layer, the second electrode, and the barrier layer have a second three-dimensional structure modeled on the projections in the first three-dimensional structure on the surface on the side opposite to the substrate.

18. The display device according to claim 17, wherein the plurality of projections included in the first three-dimensional structure have the same shape one another.

19. The display device according to claim 17, wherein the first three-dimensional structure has two or more kinds of projections, and
the projections have the same shape by kind.

20. The display device according to claim 17, wherein the plurality of projections have regularity in nano order at least in a first direction of a stack layer plane.
